(19) United States
(12) Patent Application Publication
(10) Pub. No.: US 2004/0051512 A1
(43) Pub. Date: Mar. 18, 2004

(54) Digitally modulated power control device

(75) Inventor: Chung Yung Tsai, Industrial Park (TW)

Correspondence Address: BACON & THOMAS, PLLC, 625 SLATERS LANE, FOURTH FLOOR, ALEXANDRIA, VA, 22314

(73) Assignee: ASN Technology Corp., Tainan (TW)

(21) Appl. No.: 10/622,548

(22) Filed: Jul. 21, 2003

(30) Foreign Application Priority Data
Jul. 22, 2002 (TW) 91116253

(51) Int. Cl. G05F 1/40

(52) U.S. Cl. 323/283

(57) ABSTRACT

A digitally modulated power control device comprises an input unit for inputting an AC voltage signal and a control signal; a signal detection unit for detecting the AC voltage signal and a frequency thereof and generating a first trigger signal in response to the AC voltage signal; a control unit for receiving the control signal and the first trigger signal, processing the first trigger signal in response to the control signal, and generating a second trigger signal; and an output unit including an AC switching unit. The output unit can receive the second trigger signal for activating the AC switching unit and output an adjusted AC voltage signal for adjusting an output power of an AC load.

### BACKGROUND OF THE INVENTION

1. Field of the Invention

The present invention relates to a power control device and, more particularly, to a digitally modulated power control device with improved characteristics.

2. Description of Related Art

Conventionally, a simple conventional control device is provided and used in a fan, hair dryer, electric heater, or incandescent lamp for controlling its power, speed, or brightness. However, the conventional control device is only implemented as either a toggle switch or varistor (VDR) based controller. Generally speaking, these traditional control devices suffered from several disadvantages. For example, the toggle switch may be oxidized due to frequent switches for a long time. As a result, a spark may also occur in the opening or closing of the conventional switches, which will enhance the deterioration of these switches. Moreover, a substantially linear control of power, speed, or brightness cannot be achieved through these conventional switches. On the other hand, typical digital control is implemented through the assistance of a solid state relay (SSR). However, only a digital signal input can be recognized and used for controlling the on/off of a load. It is still impossible to change the output power through the application of SSR conveniently.

Therefore, it is desirable to provide a novel power control device to mitigate and/or obviate the aforementioned problems.

### SUMMARY OF THE INVENTION

An object of the present invention is to provide a digitally modulated power control device so as to achieve a digital control and waterproof function, and further prevent occurrence of sparks.

Another object of the present invention is to provide a digitally modulated power control device so as to achieve a linear or segmental control of speed or brightness.

To achieve the object, the digitally modulated power control device of the present invention comprises an input unit for inputting an AC voltage signal and a control signal; a signal detection unit for detecting the AC voltage signal and the frequency thereof, and further generating a first trigger signal based on the AC voltage signal; a control unit for receiving the control signal and the first trigger signal, and further processing the first trigger signal based on the control signal in order to generate a second trigger signal; and an output unit having an AC switching unit; wherein the output unit being operative to receive the second trigger signal for activating the AC switching unit and outputting an adjusted AC voltage signal for adjusting an output power of the AC load..

Other objects, advantages, and novel features of the invention will become more apparent from the detailed description when taken in conjunction with the accompanying drawings.

### BRIEF DESCRIPTION OF THE DRAWINGS

FIG. 1 is a block diagram of a preferred embodiment of power control device according to the invention;

FIG. 2 is a block diagram of a control unit of the device;

FIG. 3 is a waveform graph showing an alternating current (AC) signal converted into a zero crossing signal (ZCS) by the device;

FIG. 4 is a waveform graph showing an AC input signal, an AC output signal, and a pulse position modulation (PPM) signal; and

FIG. 5 is a plan view of the device.

### DETAILED DESCRIPTION OF THE PREFERRED EMBODIMENT

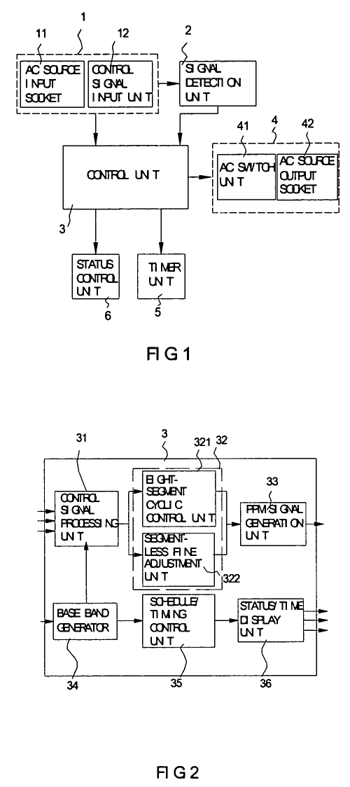

With reference to FIGS. 1 and 2, there is shown a digitally modulated power control device constructed in accordance with the invention. The digitally modulated power control device of the present embodiment includes an input unit 1, a signal detection unit 2, a control unit 3, an output unit 4, a timer unit 5, and a status control unit 6. The input unit 1 includes an AC source input socket 11 and a control signal input unit 12. The control unit 3 includes a control signal processing unit 31, a power adjustment unit 32 having an eight-segment cyclic control unit 321 and a segment-less fine adjustment unit 322, a pulse position modulation (PPM) signal generation unit 33, a base band generator 34, a schedule/timing control unit 35, and a status/time display unit 36. The output unit 4 contains an AC switching unit 41 and an AC source output socket 42. Each of above components will now be described in detail below.

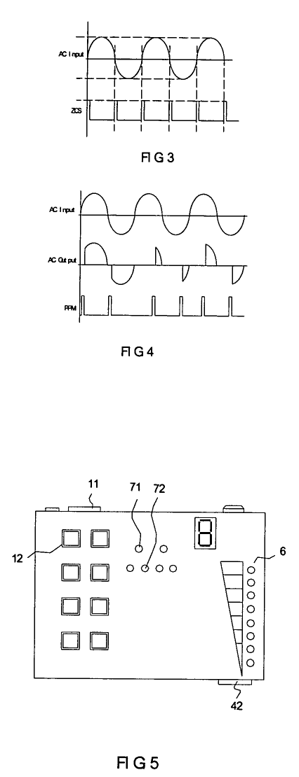

The AC source input socket 11 can be plugged in a pin for transmitting an external AC power to the signal detection unit 2. In the embodiment, voltage and frequency of the AC power are 100V to 240V and 50 Hz to 60 Hz respectively. The signal detection unit 2 here function as a detector for detecting the voltage and the frequency of the input AC power and as a generator for generating a zero crossing signal (ZCS) based on the AC power signal (e.g., 110V/60 Hz AC (i.e., sinusoidal) signal). The generated zero crossing signal (ZCS) is further sent to to the control unit 3 from signal detection unit 2, subsequently. In the embodiment, preferably the signal detection unit 2 is a zero crossing detector (ZCD). Please refer to FIG. 3. FIG. 3 is a waveform graph showing how an input AC signal is converted into a ZCS by the signal detection unit 2. The control signal input unit 12 is used for generating a control signal and sending the control signal to the control unit 3 so as to control an input voltage of an AC load, sett an operating time, or schedule an operating time and a stop time. As a result, control of the speed or the brightness of the AC load is possible.

In the embodiment, an interface implemented in the control signal input unit 12 is not restricted. Preferably, such interface is a touch panel. More preferably, such interface consists of a set of keys and a radio frequency (RF) module having a frequency of 434 MHz. The AC load is implemented as a resistive load or an inductive load. Preferably, it is a single phase AC motor, fan, hair dryer, or electric heater. More preferably, it is an incandescent lamp.

The base band generator 34 is used for receiving the control signal sent from the control signal input unit 12 prior to generate an internal control trigger signal. After the control signal is received, the base band generator 34 generate a internal control trigger signal. The internal control trigger signal is further sent to the control signal processing unit 31 and the schedule/timing control unit 35 respectively. The schedule/timing control unit 35 then performs a processing based on the internal control trigger signal in order to generate a first processing result. The first processing result is sent to the timer unit 5 and the status control unit 6 respectively via the status/time display unit 36. As a result, a time set by the control signal input unit 12 or a schedule time can be displayed. Also, a status about a speed or brightness control of the AC load is displayed.

The control signal processing unit 31 performs a processing on the received ZCS in response to the internal control trigger signal to generate a second processing result, then the second processing result is sent to the power adjustment unit 32 and the PPM signal generation unit 33 for generating a PPM signal. It is assumed that an eight-segment cyclic control is set by the control signal input unit 12, and the control signal processing unit 31 induces the PPM signal generation unit 33 to generate a PPM signal that has an eight-segment control characteristic via the eight-segment cyclic control unit 321. It is obvious that the control signal input unit 12 may be set to achieve a non-segment fine adjustment control (i.e., linear control). Hence, the PPM signal generation unit 33 will generate a PPM signal having a linear control characteristic. Likewise, the eight-segment cyclic control unit 321 may be designed as one having a number of segments less or more than eight.

In the embodiment, ZCS has a frequency of about 100 Hz to 120 Hz. The PPM signal has a frequency of about 21.6 KHz. Also, the PPM signal has a frequency of about 100 Hz to 120 Hz.

The AC switching unit 41 takes the PPM signal outputted from the control unit 3 as a trigger signal for cutting a waveform of input voltage so as to control an on/off of output power or increase or decrease the output power. In the embodiment, the AC switching unit 41 is a power electronics element. Preferably, the AC switching unit 41 is a tri-electrode AC switch (TRIAC). The waveform of FIG. 4 shows AC output signal outputted by control unit 3 and PPM signal outputted by the AC switching unit 41 versus the AC input signal.

FIG. 5 is a plan view of the device of the invention. As shown, the device comprises the AC source input socket 11, the control signal input unit 12 having a number of keys, the timer unit 5, the status control unit 6, and a plurality of light emitting diodes (LEDs) 71 and 72 for displaying a control mode of the control unit 3.

In brief, the invention utilizes the ZCD to detect the ZCS of the input AC signal. The control unit receives the control signal and the ZCS and processes the ZCS based on the control signal in order to generate a PPM signal and sent the PPM signal to the AC switching unit for cutting a waveform of input voltage so as to control an on/off of output power or increase or decrease the output power. As an end, a digital control is effected. Moreover, spark is prevented from occurring. Further, a linear or segmental control of speed or brightness is achieved.

Although the present invention has been explained in relation to its preferred embodiment, it is to be understood that many other possible modifications and variations can be made without departing from the spirit and scope of the invention as hereinafter claimed.

What is claimed is:

1. A digitally modulated power control device, comprising:
an input unit for inputting an AC voltage signal and a control signal;
a signal detection unit for detecting the AC voltage signal and the frequency thereof, and further generating a first trigger signal based on the AC voltage signal;
a control unit for receiving the control signal and the first trigger signal, and further processing the first trigger signal based on the control signal in order to generate a second trigger signal; and
an output unit having an AC switching unit; wherein the output unit being operative to receive the second trigger signal for activating the AC switching unit and outputting an adjusted AC voltage signal for adjusting an output power of the AC load.

2. The power control device as claimed in claim 1, wherein the control unit comprises a control signal processing unit, a power adjustment unit, and a second trigger signal generation unit, the control signal processing unit being operative to receive the control signal and the first trigger signal for processing the same, controlling the second trigger signal generation unit via the power adjustment unit, and outputting the second trigger signal.

3. The power control device as claimed in claim 2, wherein the power adjustment unit comprises a plurality of segments cyclic control unit and a segment-less fine adjustment unit, the plurality of segments cyclic control unit being operative to control the second trigger signal generation unit to generate a segmental control second trigger signal, and the segment-less fine adjustment unit being operative to control the second trigger signal generation unit to generate a linear control second trigger signal.

4. The power control device as claimed in claim 1, wherein the input unit comprises an AC source input socket and a control signal input unit.

5. The power control device as claimed in claim 4, wherein the control signal input unit is either a touch panel or a set of keys and a radio frequency module.

6. The power control device as claimed in claim 1, wherein the signal detection unit is a zero crossing detector (ZCD) for generating a first trigger signal taken as a zero crossing signal.

7. The power control device as claimed in claim 1, further comprising a timer unit, a status control unit, and a plurality of light emitting diodes (LEDs) for displaying a control status of the control unit.

8. The power control device as claimed in claim 1, wherein the AC switching unit is a tri-electrode AC switch (TRIAC).

9. The power control device as claimed in claim 1, wherein the second trigger signal is a pulse position modulation (PPM) signal.

10. The power control device as claimed in claim 1, wherein the AC load is either a resistive load or an inductive load.

11. The power control device as claimed in claim 1, wherein the AC load is a single phase AC motor, fan, hair dryer, electric heater, or incandescent lamp.
